(19) United States
(12) Patent Application Publication
(10) Pub. No.: US 2003/0113416 A1
(43) Pub. Date: Jun. 19, 2003

(54) Metal container with seam connecting body and top portion

(76) Inventors: Paul Anthony Wycliffe, Kingston (CA); Melville Douglas Ball, Kingston (CA); Lloyd Wilson, Aurora, IL (US)

Correspondence Address: COOPER & DUNHAM LLP, 1185 Ave. of the Americas, New York, NY, 10036, US

(21) Appl. No.: 10/016,928

(22) Filed: Dec. 14, 2001

(51) Int. Cl. A23B 4/00

(52) U.S. Cl. 426/131

(57) ABSTRACT

A container such as a can of carbonated beverage, including an upwardly open metal body having a sidewall with an annular upper portion having a reduced-diameter neck formed therein, and a metal top structure such as a lid having an annular portion secured to the annular upper portion of the sidewall along an annular seam extending outwardly and substantially horizontally or downwardly, from the sidewall. The sidewall edge portion is formed into an outwardly projecting annular flange immediately above the neck, the annular lid portion overlies the annular flange, and the seam includes a metal member holding the annular peripheral lid portion and the annular flange together. The lid may be upwardly domed by internal pressure. A method of producing the container by filling it, adhesively bonding the lid to the flange, and forming the metal seam member.

### BACKGROUND OF THE INVENTION

This invention relates to metal containers of types having a side wall with an annular upper extremity and a metal end or lid secured thereto along a seam. In an illustrative specific aspect, the invention relates to cans for holding carbonated beverages or other contents that exert a positive internal pressure on the can, and also to packages including such cans and contents, and methods of producing such packages.

A typical present-day commercially available carbonated soft drink can has a so-called drawn-and-ironed aluminum alloy can body with an integral, inwardly domed bottom and a generally cylindrical vertical side wall; a substantially rigid aluminum alloy can lid or end peripherally secured to the annular open upper extremity of the body side wall; and a removable closure provided in the lid to enable a consumer to drink or pour the beverage from the can (directions, such as “upper” or “upwardly,” “vertical” and “horizontal,” herein refer to a can standing upright with the lid at the top). Strength, gauge and design requirements, imposed primarily by the substantial internal pressure in the filled can, are determined by the need to prevent (1) dome reversal of the can body, (2) buckling of the can lid, (3) failure or leakage where the lid is secured to the body wall, and (4) failure or leakage at the closure.

In this conventional can, the lid is countersunk annularly within its periphery and, outwardly of the countersunk area, is joined to the upper extremity of the can body wall along an upstanding (substantially vertically oriented) continuous annular double seam, by a sequence of forming steps that bend overlying edge portions of the lid and the body wall upper extremity into interlocking hook profiles tightly crimped together. A lining compound applied before forming to surfaces of the metal makes the double seam gas tight, but the double seam relies on the strength of the metal for structural integrity.

It has not generally been feasible to use a conventional heat sealable and manually peelable closure in a carbonated beverage can of the type described, because the internal pressure in the can (up to 90 p.s.i., or even higher) would cause burst failure of the closure unless the heat seal bond were made too strong for practicable manual peeling. Instead, the end of such a can has commonly been formed with a scored area and provided with a riveted tab system so designed that, when lifted, the tab exerts a downward force by lever action that generates a fracture along a scored line while causing the region of the lid that lies within the scored area to bend down into the top of the container, thereby to create an aperture.

However, copending U.S. patent application Ser. No. 09/905,310 (filed Jul. 13, 2001, and assigned to the same assignee as the present application), the entire disclosure of which is incorporated herein by this reference, describes (inter alia) a can with an annular flange formed in a portion of the lid and projecting upwardly from the lid upper surface, the flange having an upwardly sloping outer surface and an annular inner edge lying substantially in a plane and defining an aperture; and a flexible closure member of deformable material comprising a metal foil, extending entirely over the aperture and peelably bonded by a heat seal to the flange outer surface entirely around the aperture. The aperture diameter, the flange slope angle, and the deformability of the closure material may be mutually selected so that the closure member, when subjected to differential pressures up to at least about 90 psi in the can, bulges upwardly with an arc of curvature such that a line tangent to the arc at the inner edge of the flange lies at an angle (to the plane of the flange inner edge) not substantially greater than the angle of slope of the flange outer surface, thereby to eliminate any peeling component of the force exerted by the pressure on the closure member and heat seal. (“Peeling force” or “peeling component of force” is used herein to describe components of force normal to the plane of an adhesive bond.) In consequence, a peelably bonded closure member may be used on a carbonated beverage can, i.e., because the forces acting on the peelably bond are predominantly shear forces.

### SUMMARY OF THE INVENTION

The present invention in a first aspect contemplates the provision of a container (e.g. a carbonated beverage can) including a metal container body having an open upper extremity and a sidewall with an inner surface, an outer surface and an annular upper edge portion at the aforesaid upper extremity, and a metal lid having an upper surface, a lower surface and an annular peripheral portion secured to the upper edge portion of the sidewall along an annular seam, wherein the improvement comprises, in combination, the upper edge portion of the sidewall being formed into an outwardly projecting annular flange with an upper surface that is continuous with the inner surface of the sidewall; the annular peripheral lid portion overlying the annular flange and having no return bend; the lower surface of the lid at the annular peripheral portion facing and being adhesively bonded to the upper surface of the annular flange; and the seam including a metal member extending around the annular peripheral lid portion and bearing against the upper surface of the lid to hold the annular peripheral lid portion and the annular flange together.

In particular embodiments, the metal seam member is an integral outer portion of the annular flange extending beyond the annular peripheral lid portion, formed with a return bend to overlie the annular peripheral lid portion of the lid and crimped to hold the lid against the flange. In other embodiments, the metal seam member is an inwardly opening U-shaped metal ring formed around and gripping the annular peripheral lid portion and the annular flange to hold them together.

Containers of the type described may be used to hold products, such as carbonated beverages, that exert a positive internal pressure, and in such case the lid may be upwardly domed by the pressure within the container. The lid may define an aperture for discharging the contents of the container, and may further include a flexible closure member (e.g. as described in the aforementioned copending application) extending entirely over the aperture and peelably bonded to the upper surface of the lid.

In embodiments wherein the container is a can, the body is a can body having a sidewall formed with a reduced-diameter neck immediately below the annular flange. Where the sidewall extends generally vertically, the seam either may extend generally horizontally or downwardly, or may be bent so as to project generally upwardly from the neck. In the latter case, if the lid is upwardly domed, the seam may project above the domed lid so that cans may be stacked vertically, one on another; thus, although such a seam is not a seam extending substantially horizontally or downwardly from the sidewall, it affords other advantages.

Further aspects of the invention include a carbonated beverage package comprising a container as described above and a body of a carbonated beverage contained therein, and a method of producing such a container holding a carbonated beverage, comprising filling the container body with the beverage, disposing the lid in overlying relation to the annular flange, adhesively bonding the lower surface of the annular peripheral portion of the lid to the upper surface of the annular flange, and forming the metal seam member to extend around the annular peripheral lid portion and bear against the upper surface of the lid to hold the annular peripheral lid portion and the annular flange together.

The present invention in a still further broad aspect embraces the provision of a container comprising a generally axially vertical container body including an open upper extremity and a metal sidewall with an outwardly projecting annular upper portion having an extended surface, the sidewall being formed with a reduced-diameter neck immediately below the outwardly projecting annular portion; and a metal top structure including an outwardly projecting annular portion with an extended surface in juxtaposed facing relation to the aforesaid extended surface of the annular upper portion of the sidewall, the annular portion of the top structure being secured to the annular upper portion of the sidewall along an annular seam extending outwardly and substantially horizontally or downwardly from the sidewall; the seam including a metal seam member holding the annular portion of the top structure and the annular upper portion of the sidewall together. The metal top structure may have an aperture formed therein.

In particular embodiments of this container, the metal seam member may comprise a region of the annular portion of the sidewall that is welded to the annular portion of the top structure. Alternatively, the juxtaposed extended surfaces of the annular portions of the sidewall and the top structure may be adhesively bonded together; and the metal seam member may comprise an integral outer part of the annular portion of the sidewall, formed with a return bend to extend around the annular portion of the top structure and crimped to hold the annular portion of the top structure against the annular portion of the top structure, or it may comprise an inwardly opening U-shaped metal ring formed around and gripping the annular portions of the sidewall and the top structure to hold them together. A metal seam member of either of these latter types may have an inwardly curled outer edge to avoid exposure of a cut metal edge. “Substantially horizontal” as used herein refers to a seam or surface oriented in a plane perpendicular to the vertical container body axis, or departing from such plane by an angle A of not more than about 45°, as distinguished from the upstanding (vertical or near-vertical) seams of conventional cans with drawn and ironed bodies for holding such products as carbonated beverages. The seam and surfaces described as “substantially horizontal” are not necessarily planar but may be partially or continuously curved provided that over a radially extended area the tangent to such curve, though varying in angular orientation, remains substantially horizontal.

A substantially horizontal seam affords advantages including avoidance of accumulation of contaminant material or dirt in a narrow crevice inwardly of the seam. The advantage of avoidance of dirt accumulation is also realized for embodiments where the flange is angled downwardly (A<0°).

Further features and advantages of the invention will be apparent from the detailed disclosure hereinbelow set forth, together with the accompanying drawings.

### BRIEF DESCRIPTION OF THE DRAWINGS

FIG. 1 is a perspective view of a carbonated beverage can which is generally conventional but has a closure member of a type described in the aforementioned copending application;

FIG. 2 is a side elevational view, partly broken away, of two cans of the structure shown in FIG. 1, stacked vertically;

FIG. 3 is a simplified fragmentary elevational sectional view of the upper portion of a can as shown in FIG. 1, illustrating a conventional body-lid seam;

FIG. 4 is an enlarged fragmentary elevational sectional view of the body-lid seam;

FIGS. 5A, 5B and 5C are simplified fragmentary sectional views illustrating successive steps in forming the seam of FIG. 4, with an element of the tooling for each step separately shown at reduced scale above the illustration of the step to which it pertains;

FIG. 6 is a simplified fragmentary elevational sectional view, similar to FIG. 3, of the upper portion of a can embodying the present invention in a particular form;

FIG. 7A is an enlarged schematic fragmentary elevational sectional view of the body-end seam of the embodiment of FIG. 6;

FIG. 7B is an enlarged schematic fragmentary elevational sectional view of the upper portion of an embodiment similar to the can of FIG. 6, but with a somewhat modified seam structure, identifying various dimensions;

FIG. 7C is an enlarged schematic fragmentary elevational sectional view, similar to FIG. 7A, of another modified seam structure in an embodiment similar to the can of FIG. 6;

FIGS. 8A, 8B and 8C are fragmentary schematic sectional views illustrating successive steps in forming the lid-body seam of the can of FIG. 7B;

FIGS. 8D and 8E are views similar to FIGS. 8A and 8C, respectively, illustrating steps in forming the seam of FIG. 7C;

FIGS. 9A, 9B and 9C are fragmentary schematic sectional views illustrating successive steps in further forming the lid-body seam of the can of FIG. 7B to produce a modified seam configuration in a can also embodying the invention;

FIG. 10 is a fragmentary schematic sectional view of another modified seam configuration in a can also embodying the invention; and

FIGS. 11A, 11B, 11C and 11D are similar fragmentary schematic sectional views of four further seam configurations in cans embodying the invention.

### DETAILED DESCRIPTION

Merely for purposes of illustration, the invention will be described as embodied in a carbonated beverage can which is generally conventional (except for the features of the lid-body seam hereinafter described, and the use of a peelable closure of a type described in the aforementioned copending application), including a drawn and ironed can body (made of a suitable aluminum alloy) with a vertical, generally cylindrical sidewall and an inwardly (upwardly) domed bottom integral with the sidewall. It is to be understood, however, that the invention in its broader aspects is not limited to cans or bodies of this type or configuration.

Prior Art

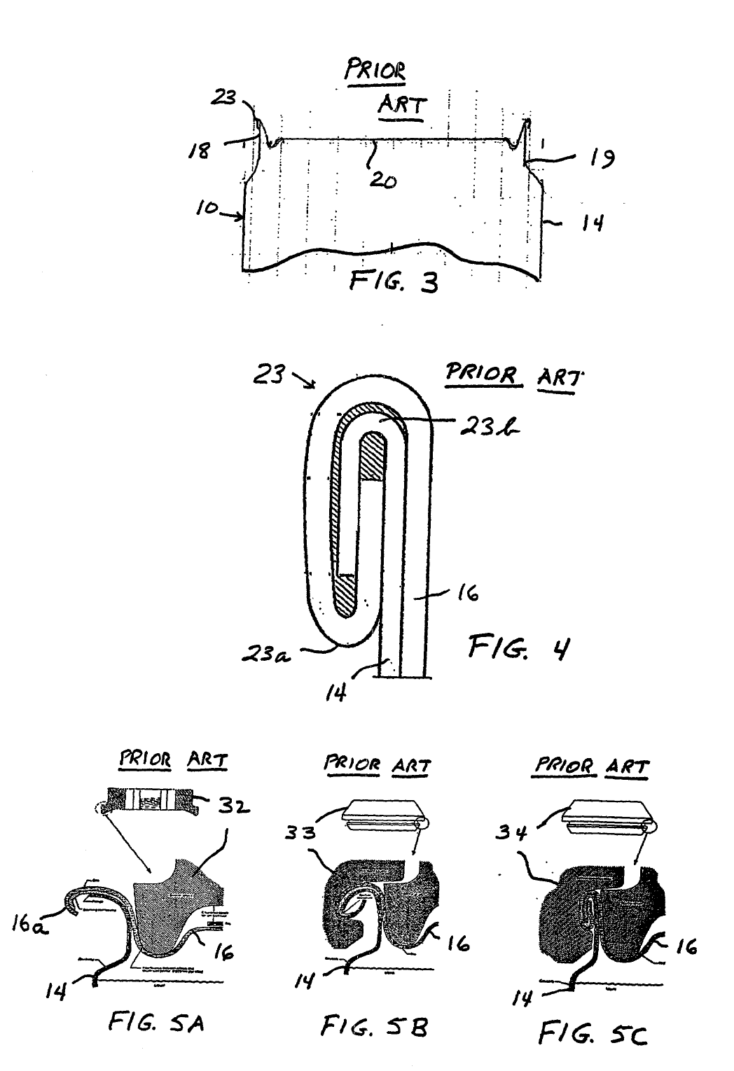

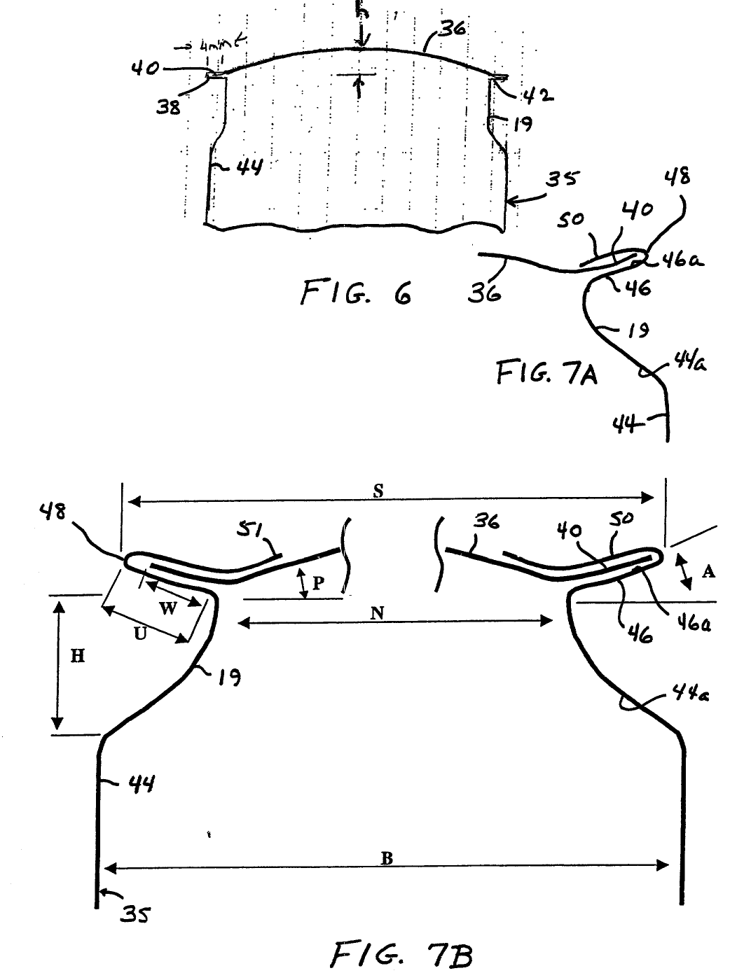

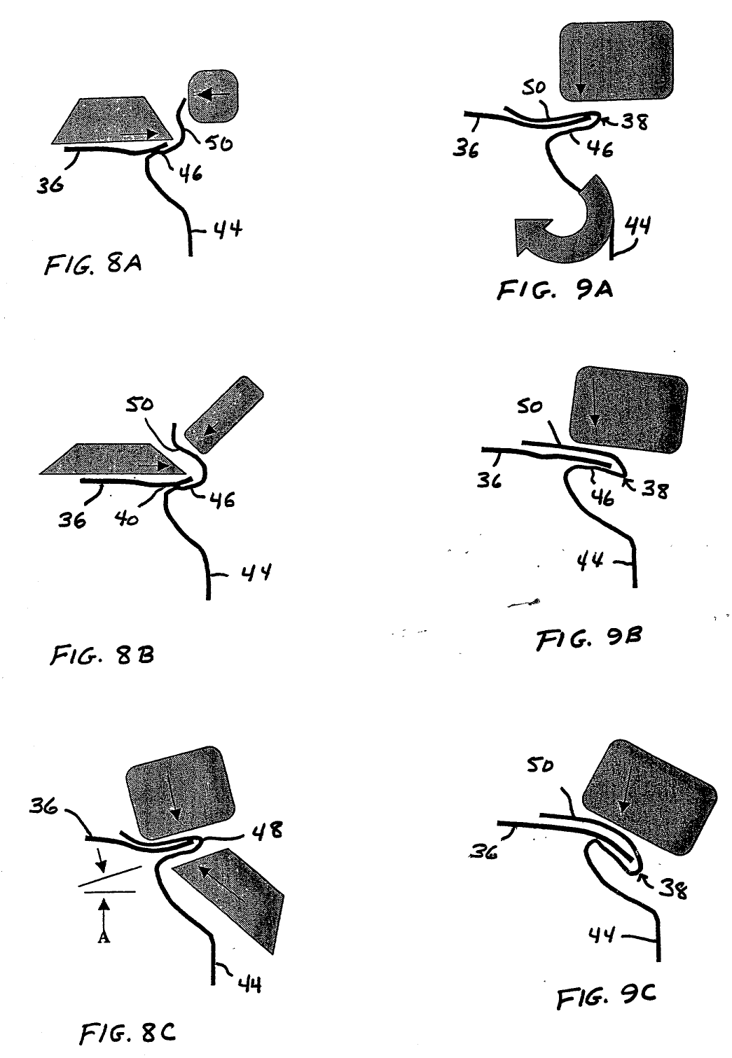

To explain one exemplary and important environment of use of the present invention, reference may be made to the prior art (and, in part, to the subject matter of the aforementioned copending application) as represented in FIGS. 1-4 and 5A-5C. The can of FIGS. 1-5 has a closure of a type described in the aforementioned copending application but is otherwise a wholly conventional metal can 10 as used in present-day commerce for holding a carbonated beverage such as soda or beer. It includes a one-piece can body 11 constituting the bottom 12 and continuous, upright, axially elongated, generally cylindrical sidewall 14 of the can, and a lid 16 which, after the can has been filled with the beverage, is peripherally secured to the open top end of the can body to provide a complete, liquid-tight container.

The body 11 is an entirely conventional drawn-and-ironed aluminum alloy can body, i.e., having the structure, alloy composition, method of fabrication, configuration, gauge, dimensions and surface coatings to can bodies currently commercially used for carbonated and other beverages (alternatively, for example, the body may be a steel can body, such as are in common use in Europe). The terms “aluminum” and “aluminum alloy” are used interchangeably herein to designate aluminum metal and aluminum-based alloys. In particular, the bottom 12 of the body 11 is externally concave and the open top end of the body has a circular edge 18 lying in a plane perpendicular to the vertical geometric axis of the side wall 14. Immediately below edge 18 the sidewall is necked (reduced in diameter) as indicated at 19.

Except as hereinafter described, the lid 16 of the can of FIG. 1 is also a generally conventional aluminum alloy lid member of the type currently commercially used for beverage cans having drawn and ironed one-piece can bodies such as the body 11. Thus, the alloy of which it is constituted, the steps and procedures employed in its fabrication (with the exceptions noted below), and its general overall configuration, dimensions, gauge and surface coatings as well as the manner in which it is secured to the top edge 18 of the can body 11, are all characteristic of present day can lids well-known in the art.

In particular, the lid 16 of the FIG. 1 can is substantially rigid, and has a substantially flat upper surface 20 with a circular periphery, around which is formed a raised annular rim 22 projecting upwardly above the plane of the flat upper surface 20. When the lid is mounted on the open upper end of a beverage-filled can body, in known manner, the rim 22 engages the upper edge 18 of the can body along a continuous annular double seam 23; the circular flat surface 20 lies substantially in a horizontal plane, perpendicular to the vertical geometric axis of the cylindrical side wall 14, and is centered with respect to the latter axis.

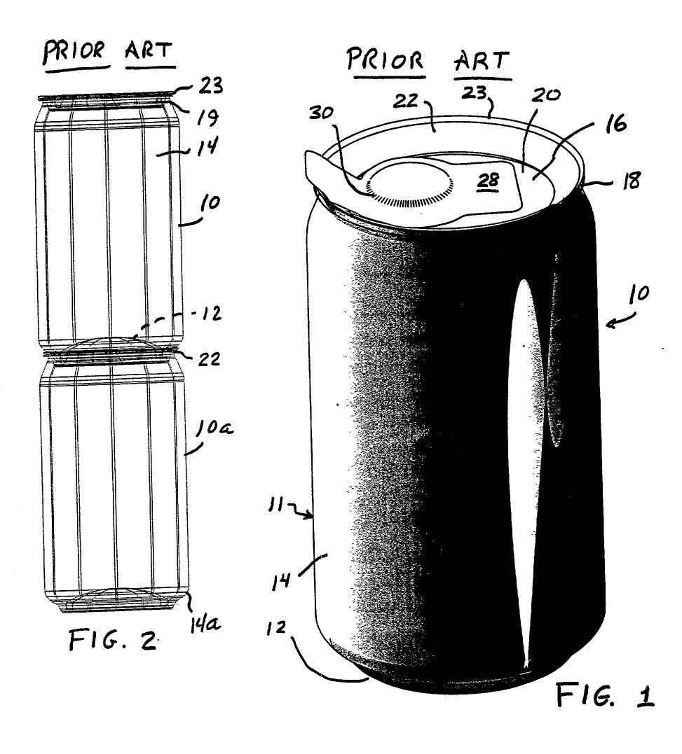

The lower end 14a of the side wall 14 of the can 10 is shaped (tapered) to interfit with the rim 22 of the lid of another identical can 10a, when the can 10 is stacked vertically on top of the can 10a as shown in FIG. 2. A multiplicity of the cans may thus be stably vertically stacked, one on another, as is true of present-day conventional cans of the same general type. The elevation of the lid rim 22 above the flat upper surface 20 of the lid, together with the concavity of the can bottom 14, cooperatively define a central gap or space between the lid of one can and the bottom of the next can above it, in such a stacked arrangement. As will be apparent from FIGS. 1, 3 and 5A-5C, the lid is countersunk in an annular region immediately inward of its periphery.

The lid 16, when secured to the beverage-filled can body, provides therewith a complete sealed enclosure holding the beverage. The lid is thus subjected to elevated internal pressure within the can (i.e., pressure higher than ambient atmospheric pressure) if the beverage is carbonated. However, the formed aluminum alloy lid is substantially rigid, so that it undergoes at most only a small deflection of its upper surface as a result of this pressure condition, and the upper surface 20 remains substantially flat notwithstanding the internal pressure acting on the lid.

The lid 16 is arranged to provide an aperture through which the beverage contained in the can may be poured or removed by drinking directly from the can, either with a straw inserted through the aperture or by juxtaposition of the consumer's mouth to the aperture. Heretofore, in cans for holding carbonated beverages or other such contents at elevated pressure, the aperture-providing feature has conventionally included a scored portion of the metal of the lid member and a riveted pull tab system for parting the lid metal along the score line to open the aperture. As mentioned above, however, in accordance with the subject matter of the aforementioned copending application, a pre-formed open aperture is provided in the lid, and a peelable, flexible closure member 28 is also provided, to cover the aperture. In order to achieve adequate burst resistance without requiring excessive force to peel the closure member, a shallow upwardly projecting (e.g., frustoconical) annular flange 30 (indicated in FIG. 1 only as a relief feature under the closure member) is formed in the lid within the area of the flat upper surface 20, to surround and define the aperture 24 and to provide a seat for the closure member. Details of the structure, design and function of the closure member, flange and aperture are set forth in the aforementioned copending application, to which reference may be made for a full description thereof.

The seam 23 by which the lid is secured to the body sidewall 14 is, as best seen in FIG. 4, an upstanding double seam produced by a succession of forming operations (portions of which are represented in FIGS. 5A-5C, with the tools 32, 33, 34 employed in those operation) which concurrently impart two return bends to the outer annular peripheral edge portion 16a of the lid 16, and one return bend to the upper marginal edge portion of the sidewall 14, thereby to constitute these edge portions as mating (i.e., interlocked) hooks 23a, 23b which are tightly crimped together. By “return bend” is meant a bend through substantially 180°.

At its central portion, the seam is five layers of metal thick (three layers of lid, two of sidewall). A lining compound is used to make the double seam gas tight, but the double seam uses the strength of the metal to give it structural integrity.

The necessity of forming the lid periphery into the double seam 23 imposes a requirement of at least modest formability on the lid material. Strength and gauge requirements for the conventional lid 16 are largely associated with the avoidance of buckling of the lid under the elevated internal pressures to which it is subjected. Buckling is liable to occur because the countersink of the conventional lid is outwardly concave. Features of the lid configuration are, in turn, related to the requirements for producing and using the scored area and riveted tab system to open the aperture in the lid.

The Present Invention

With the replacement of the rivet, tab and scored area by the peelable closure of the aforementioned copending application, it becomes possible to secure the lid to the sidewall by a simplified seam design, since the lid can be allowed to become convex, without a countersink. Thereby, strength, gauge and formability requirements for the lid can all be reduced.

The container of the present invention, now to be described by reference to the specific embodiments illustrated in FIGS. 6-11B, may include (for example) a drawn-and-ironed can body 35 identical to the can body 11 shown in FIGS. 1-4 (except for the outwardly projecting annular flange at the top, described below), but replaces the substantially rigid lid 16 with a lid 36 having no countersink. The lid 36 is fabricated (for example) of an aluminum alloy, which may be lower in strength and formability that the alloys heretofore used for conventional can lids such as the lid 16 in FIG. 1. In addition, the lid may be thinner in gauge than the prior art lids. As secured to the top of a can holding contents (such as a carbonated beverage) that exert a substantial internal pressure, the lid is upwardly domed (i.e., outwardly convex) ; it does not have to be preformed to the domed shape, but may be allowed to bulge in this manner under the influence of the internal pressure after it is mounted on the can body. Thus, the lid may initially be a simple flat disk of aluminum alloy sheet of the appropriate diameter.

Further, the present invention replaces the conventional double seam 23 of the prior art cans with a single reinforced seam 38 (as shown, e.g., in FIGS. 6, 7A, 7B, 7C and 8A-8E) in which an annular peripheral portion 40 of the lid 36 is engaged. This annular peripheral lid portion 40 in the seam has no return bend (in contrast to the two return bends formed in the lid 16 to produce seam 23), thereby reducing or even virtually eliminating formability requirements for the lid material.

The lid 36 is secured along seam 38 to the annular upper edge portion 42 of the sidewall 44 of the can body 35. As best seen in FIGS. 7A, 7B, 7C and 8A-8E, sidewall edge portion 42 is formed into an annular flange 46 projecting outwardly from the necked portion 19 of the sidewall so that its upper surface 46a is continuous with the inner surface 44a of the sidewall. The lid 36 overlies the flange 44 with the surface of the annular peripheral lid portion 40 facing and adhesively bonded to the upper surface 46a of the sidewall annular flange 46. The term “adhesively bonded” is used herein to refer to bonding with an adhesive material (e.g. a heat seal material) interposed between the respective facing surfaces of the peripheral lid portion 40 and the annular flange 46, as distinguished from welding, soldering, brazing or other metal-to-metal bonding.

Where a heat seal is used, a suitable heat seal coating formulation may be applied to one of the facing surfaces of the lid and annular flange, prior to assembly, and activated by heat after the surfaces to be bonded are brought into facing contact. Suitable compositions, procedures and equipment for heat sealing are well known in the art and accordingly need not be described in detail.

In the embodiments of FIGS. 6, 7A, 7B and 7C, the annular flange 46 of the sidewall is wider than the annular peripheral lid portion 40. When the lid is disposed in overlying relation to the flange for closing the can, as shown, the flange 46 extends outwardly beyond the outer edge of the lid entirely around the lid periphery, and is formed with a return bend 48 so that its outermost portion 50 extends upwardly around the outer edge of the lid and inwardly over the upper surface of the annular peripheral lid portion to bear against the upper lid surface. Thus, the seam 38 is constituted of the annular peripheral lid portion 40, the inner portion of the annular flange 46 which underlies the lid portion 40, the adhesive bond between the lid portion and flange, and the outer annular flange portion 50, which constitutes a metal seam member and is crimped to hold the lid against the flange.

Inwardly of the seam, the lid is bulged (by positive pressure within the can) into an upwardly convex dome. The internal pressure exerts components of shear force and peeling force on the seam. The adhesive (e.g. heat seal) bond withstands shear loading while the metal seam member constitutes the primary reinforcement of the seam against failure resulting from peeling force.

In the embodiment shown in FIG. 7A, the width of the annular flange 46 is about twice that of the annular peripheral lid portion 40 overlying the flange, so that the return-bend outer portion 50 of the flange is about equal in width to the lid portion 40. Alternatively, as shown in FIG. 7B, the width of the annular flange may be more than twice that of the annular lid portion 40 that overlies the flange, so that the flange outer portion 50 extends inwardly over the lid as indicated at 51, beyond the inner diameter of the annual flange, to provide additional reinforcement. Another alternative is shown in FIG. 7C, where the flange is curled over itself (at 52) curving inward, so that the cut metal edge is neither exposed to the consumer, nor is it in contact with the thin can lid 36.

The seam 38 of FIGS. 7A and 7B extends generally horizontally outwardly from the necked portion of the vertical can wall. Since the lid 36 is bulged or domed upwardly by internal pressure, the dome is proud of (rises above) the can seam by an amount h as indicated in FIG. 6.

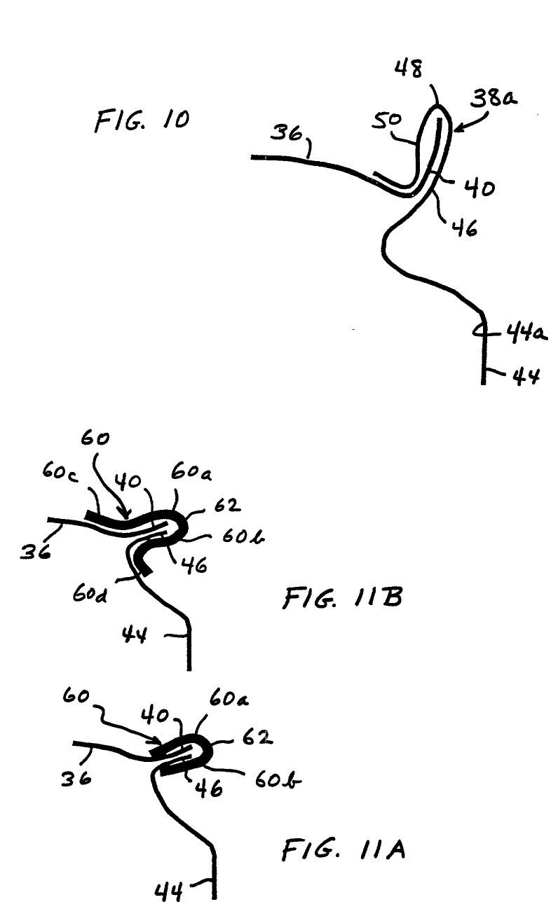

In a further alternative, illustrated in FIG. 10, the seam is subjected to a final, approximately right-angle upward bend 54 to form an upstanding seam 38a which projects above the domed can end; i.e., the upwardly bent seam 38a is the highest part of the can, enabling the can to bear vertical loads, and, in particular, to be stacked vertically with other identical cans as in the conventional manner represented in FIG. 2. Whereas the peeling forces act against the metal seam member 50 in the configuration of FIGS. 7A and 7B in a direction to tend to push the seam open, the angle of the seam 38a in FIG. 10 may reduce the tendency for internal pressure to bend the seam open.

Although the modification of FIG. 10 imposes an approximately right-angle bend on the lid 36 at or just inwardly of the annular peripheral lip portion 40, there is still no return bend (or any comparable severity of forming) imposed on the lid. All the seam designs of FIGS. 6, 7A, 7B, 7C and 10, however, may require greater strength and/or formability of the upper portion (so-called “thickwall”) of the can sidewall 44 than is required of the corresponding sidewall portion of a drawn-and-ironed can body when a conventional double seam 23 is employed. For example, heat treatment of the top part of the can (e.g. by induction heating) may be required in order to improve the formability of the ironed can sidewall.

In this regard, it may be explained that in conventional forming of a drawn-and-ironed can body, the reduced diameter of the punch near the top of the can body typically gives a thickwall of about 0.0055 inch while the thinwall (lower portion of the can body wall) is typically 0.0038 inch. The thickwall thickness cannot be increased without constraint since the thickwall dimension must be slightly less than the clearance of the second ironing ring. Increasing the thickwall thickness, with the thinwall dimension fixed, increases the reduction by the third ironing ring, which makes the ironing process more demanding.

Like the lid 16 of the can of FIG. 1, the lid 36 is formed with an aperture that is closed by a peelable closure member (omitted, for simplicity, from FIGS. 6-12), e,g., a foil or like flexible closure member heat sealed to the lid and domed by pressure within the can. As described in the aforementioned copending application, the slope of the surface (or of the tangent to the surface, if curved) to which the closure member is bonded is sufficient to substantially eliminate any component of peel force (owing to internal pressure within the can) that could cause burst failure of the closure. The requisite surface slope may be achieved by forming the lid with a raised flange around the aperture, i.e., in the manner indicated at 30 in FIG. 1, if the upward curvature of the domed lid itself is not sufficient.

Referring again to FIG. 6, in an exemplary carbonated beverage can of conventional body dimensions embodying the present invention as there shown, the horizontal seam width is 4 mm, the internal pressure is 90 psi, the end (lid) thickness is 0.114 mm, and the applied stress is 240 MPa.

The following Table 1, where the letters identify the same dimensions as in FIG. 7B, compares typical dimensions (in mm) of a conventional carbonated beverage can with typical dimensions and preferred and working ranges for the embodiment of FIG. 7B:

TABLE 1

| | | | FIG. 7B Can | | | | |
|---|---|---|---|---|---|---|---|
| | Conventional | | | Preferred | | Working | |
| | Can | | | range | | range | |
| | | mm. | Typical | min | max | min | max |
| S | Diameter of | 61.0 | 68 | 19 | 90 | 8.0 | 300 |
| | seamed end | | | | | | |
| N | Diameter of | 60.4 | 60.4 | 16 | 86 | 8.0 | 300 |
| | can neck | | | | | | |
| H | axial height of | 10.2 | 10.2 | 8 | 40 | 3.0 | 140 |
| | reduced can | | | | | | |
| | diameter | | | | | | |
| B | Diameter of can | 68.1 | 68.1 | 40 | 90 | 30.0 | 300 |
| | body | | | | | | |
| W | Width of seam | 1.0 | 1.5 | 0.3 | 2 | 0.1 | 4 |
| | overlap | | | | | | |
| U | Distance from | 3.3 | 4 | 1.5 | 6 | 1.0 | 10 |
| | outer part of | | | | | | |
| | seam to neck | | | | | | |
| | metal thicknesses | | | | | | |
| | Can End | 0.216 | 0.114 | 0.1 | 0.2 | 0.1 | 0.3 |
| | Thin Wall | 0.097 | | | | | |
| | Thick Wall | 0.165 | | | | | |
| P | angle of panel | 0 | 25 | 8 | 35 | 0 | 80 |
| | (from horizontal) | | | | | | |
| A | angle of seam | 90 | 0 | −10 | 45.00 | −80 | 90 |
| | (from horizontal) | | | | | | |

More generally, in the FIG. 7B embodiment, the dimension S should be less than B (the width of the can end should not be greater than that of the body). For angle A=0° (horizontal seam, as shown in FIG. 6), S=N+2 U; for A>0, S=N+2 U cos A. P will always be greater than zero for any can with internal pressure, since the can end will bulge. A currently preferred range for angle A is −20° to +45°.

FIGS. 8A, 8B and 8C illustrate one exemplary sequence of forming operations for sealing the can of FIG. 7B after the can body has been filled (e.g. with a carbonated beverage), and the initially flat disk-shaped lid 36 is disposed with its annular peripheral portion 40 facing downwardly in overlying relation to the inner part of the upper surface of the annular wall flange 46. It will be appreciated that an adhesive (e.g. heat seal) coating is pre-applied to at least one of the facing surface portions of the lid and flange 46 and, at an appropriate point in the seam-forming procedure, activated as by heat to create an adhesive bond between overlapping surfaces of lid and flange.

The final stage of forming the seam typically involves squeezing (crimping) the bent flange and the lid periphery together. As FIG. 8C shows, this operation requires tooling contact with the underside of the flange 46 after the can is filled. When angle A increases, and/or when the dimension H increases, the flange underside is more accessible to the tooling. FIGS. 8D and 8E illustrate two steps in the sequence where the can body has an inward curled edge 52 (as in FIG. 7C). Comparing these steps with FIGS. 8A and 8C shows that the curled edge does not have a large effect on the sequence of operations for sealing the can.

Lack of access to the underside of the flange may preclude large initial negative values of angle A; however, large final negative values of angle A can be achieved in the produced can by pushing the flange downward in a further spinning operation after the can is filled and the seam is closed and crimped. Such an operation is illustrated in FIGS. 9A-9C, using a series of steps to minimize axial loading of the can.

Although a limited extent of downward bending is shown in FIGS. 9A-9C, the flange may bent downwardly as far as desired.

The maximum container volume for a given set of overall dimensions (i.e., maximum container diameter and total container height) is achieved by making H as low as possible, and N as large as possible. Decreasing the diameter of the can neck will reduce the height of the bulge in the can and decrease angle P.

In a present day conventional carbonated beverage can having a double seam securing the end to the sidewall, the relation between the neck and the seamed end is S=N+2 (tₑ+tₖ). The applied stress s in the thin wall of the can is given by s=pr/t where p is internal pressure and t is wall thickness. At a pressure of 100 psi, with a can radius of 34.04 mm and a wall thickness of 0.097 mm, the stress is 243 MPa.

In the present invention, the relation between applied stress in the lid, metal thickness and lid curvature is as follows: For a section of a spherical shell, the applied stress s is given by s=pr/2t where p is internal pressure, t is wall thickness and r is the radius of curvature. The bulge height h of the lid panel above the horizontal (see FIG. 6) is given by h=r−√ (r²−q²) where h is the bulge height represented in FIG. 6 and q is the radius of the lid panel; and angle P (FIG. 7B) is given by P=arc cos ([r−h]/r). The condition for having the seam (e.g., seam 38a in FIG. 10) extend to the same height as the bulged can end is U sin A=h.

Table 2 below gives the relation between applied stress in the metal, metal thickness and the bulging of the can end:

TABLE 2

| | | Metal of can end | | Shape of bulged end for | |
|---|---|---|---|---|---|
| Internal | bulge | | Applied | 61 mm. panel diameter | |
| pressure | radius | thick | stress | height | angle |
| psi | mm. | mm. | Mpa | mm. | degrees |
| 100 | 76.2 | 0.114 | 230 | 6.4 | 24.8 |
| 100 | 96.5 | 0.114 | 291 | 4.9 | 19.3 |
| 100 | 81.3 | 0.114 | 245 | 5.9 | 23.1 |
| 100 | 88.9 | 0.127 | 241 | 5.4 | 21.1 |
| 100 | 94.0 | 0.127 | 255 | 5.1 | 19.9 |
| 100 | 83.8 | 0.127 | 227 | 5.7 | 22.4 |
| 90 | 76.2 | 0.102 | 233 | 6.4 | 24.8 |
| 90 | 96.5 | 0.102 | 295 | 4.9 | 19.3 |
| 90 | 81.3 | 0.102 | 248 | 5.9 | 23.1 |
| 90 | 88.9 | 0.114 | 241 | 5.4 | 21.1 |
| 90 | 94.0 | 0.114 | 255 | 5.1 | 19.9 |
| 90 | 152.4 | 0.216 | 219 | 3.1 | 12.1 |

This shows that to get stresses typical of those in the current can wall, with the can end bulging about 5 mm, the metal thickness may be 0.1 to 0.12 mm, which is just slightly thicker than the thickness of the can wall of the conventional can body.

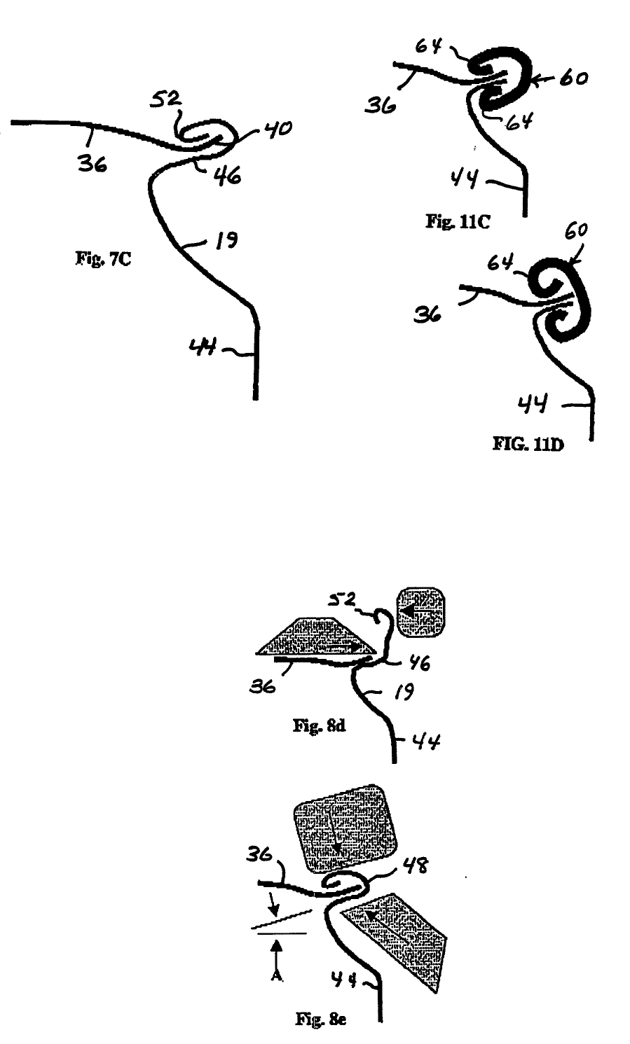

As an alternative to forming a return bend in the sidewall annular 46 (so that the outermost portion thereof serves as the metal seam member bearing on the lid 36), the annular flange and the annular peripheral portion 40 of the lid may be made substantially equal to each other in width (i.e., their edges may have substantially equal diameters) and the metal seam member may be a third metal part, viz. a metal ring formed around the outer edge portions of the lid and flange to hold them together. FIGS. 11A, 11B, 11C and 11D show four embodiments of such an arrangement. As before, the annular peripheral portion 40 of lid 36 and the annular flange 46 are facing and adhesively bonded (e.g. heat sealed) together. A ring 60 of metal (e.g. aluminum alloy strip, of heavier gauge than either the lid 36 or sidewall 44) surrounds the bonded edge portions of the lid and flange outwardly thereof, and is formed with a return bend 62 so as to have an inwardly opening U-shaped profile with one leg 60a extending inwardly above the lid and the other leg 60b extending inwardly below the flange, the legs being squeezed or crimped together the superposed flange and lid peripheral portions between them (in production of filled cans, the ring is formed with the return bend after the can has been filled and the lid has been disposed over the flange 46). Thereby, the ring 60 acts as a seam member, serving the function of the return-bent outermost portion of the flange in the embodiments of 6, 7A, 7B and 10. Arrangements shown in FIGS. 11C and 11D have the same advantage as FIG. 7C, viz., the cut metal edge of the ring 60 is curled over itself curving inwardly (at 64) so that this cut metal edge is neither exposed to the consumer, nor is it in contact with the thin can lid.

The gauge, temper and alloy composition of the ring 60 are all independent of that of the lid 36 and wall 44 of the can. Consequently, it can be made as heavy in gauge as desired to achieve a secure seam that will not open under the peeling forces exerted against the lid by elevated pressure within the can. In these embodiments, again, little deformation is required of the can lid. Each leg of the ring may be made about equal in extent to the width of the conjoined annular portions of the lid 36 and flange 44, as shown in FIG. 11A, or one or both legs may be made somewhat greater in extent, as indicated at 60c and 60d in FIG. 11B, to make the assembly stronger.

Since the area of the ring 60 is small in relation to the areas of the can lid and body, the provision of a relatively heavy gauge ring to impart strength to the seam and enable reduction in sidewall and lid thickness enables an overall net reduction in metal usage. A ring of a thicker gauge in a softer temper, for example, may be employed in these embodiments.

In still further embodiments of the invention, the seam between the can body sidewall and lid may be provided by simply positioning the annular peripheral portion of the lid in overlying relation to the annular flange of the body sidewall and welding the annular flange to the peripheral portion of the lid, for example using laser welding equipment commercially available from Raptor, Inc. In such case the metal seam member is the integral region of the annular flange that is welded to the annular peripheral portion of the lid.

With the exception of the can structures of FIGS. 9C and 10, the various embodiments of the invention herein shown and described have annular seams extending substantially horizontally outwardly from the sidewall (an precisely horizontally extending seam is one for which angle A is 0°), with correspondingly substantially horizontally facing surfaces of the annular lid portion 40 and annular flange 46.

In various embodiments of the invention, the outwardly projecting annular portion of the top structure (e.g., the annular peripheral portion of the lid, which is secured to the annular upper portion or annular flange of the body sidewall) is the lowermost portion of the top structure.

It is to be understood that the invention is not limited to the features and embodiments hereinabove specifically set forth, but may be carried out in other ways without departure from its spirit.

What is claimed is:

1. A carbonated beverage package comprising:
(a) a metal can body having an open upper extremity and including a sidewall with an inner surface, an outer surface and an annular upper edge portion at said upper extremity;
(b) a body of a carbonated beverage contained within the can; and
(c) a can lid having an upper surface, a lower surface and an annular peripheral portion secured to the upper edge portion of the sidewall along an annular seam, the lid being upwardly domed by positive internal pressure caused by the carbonated beverage within the can, the lid defining an aperture therein for pouring or drinking liquid from the can, and further including a flexible closure member extending entirely over the aperture and peelably bonded to the upper surface of the lid;
wherein the improvement comprises, in combination,
(d) the upper edge portion of the sidewall being formed into an outwardly projecting annular flange with an upper surface that is continuous with the inner surface of the sidewall, the sidewall being formed with a reduced-diameter neck immediately below the annular flange;
(e) the annular peripheral lid portion overlying the annular flange and having no return bend;
(f) the lower surface of the lid at said annular peripheral portion facing and being adhesively bonded to the upper surface of the annular flange; and
(g) the seam including a metal member extending around the annular peripheral lid portion and bearing against the upper surface of the lid to hold the annular peripheral lid portion and the annular flange together.

2. A package as defined in claim 1, wherein the seam extends outwardly and substantially horizontally or downwardly from the sidewall.

3. A container including:
(a) a metal container body having an open upper extremity and including a sidewall with an inner surface, an outer surface and an annular upper edge portion at said upper extremity; and
(b) a metal lid having an upper surface, a lower surface and an annular peripheral portion secured to the upper edge portion of the sidewall along an annular seam;
wherein the improvement comprises, in combination,
(c) the upper edge portion of the sidewall being formed into an outwardly projecting annular flange with an upper surface that is continuous with the inner surface of the sidewall, the sidewall being formed with a reduced-diameter neck immediately below the annular flange;
(d) the annular peripheral lid portion overlying the annular flange and having no return bend;
(e) the lower surface of the lid at said annular peripheral portion facing the upper surface of the annular flange; and
(f) the seam including a metal member holding the annular peripheral lid portion and the annular flange together.

4. A container as defined in claim 3, wherein the lower surface of the lid at said annular peripheral portion is adhesively bonded to the upper surface of the annular flange, and the metal seam member comprises a metal member extending around the annular peripheral lid portion and bearing against the upper surface of the lid to hold the annular peripheral lid portion and the annular flange together.

5. A container as defined in claim 4, wherein the metal seam member comprises an integral outer portion of the annular flange extending beyond the annular peripheral lid portion, formed with a return bend to overlie the annular peripheral lid portion of the lid and crimped to hold the lid against the flange.

6. A container as defined in claim 4, wherein the metal seam member comprises an inwardly opening U-shaped metal ring formed around and gripping the annular peripheral lid portion and the annular flange to hold them together.

7. A container as defined in claim 4, wherein the lid is upwardly domed by positive internal pressure within the container.

8. A container as defined in claim 3, wherein the seam extends outwardly and substantially horizontally or downwardly from the sidewall.

9. A container as defined in claim 7, comprising a can, said body being a can body, wherein the lid defines an aperture for discharging the contents of the container, and further including a flexible closure member extending entirely over the aperture and peelably bonded to the upper surface of the lid.

10. A container as defined in claim 9, wherein the metal seam member comprises an integral outer portion of the annular flange extending beyond the annular peripheral lid portion, formed with a return bend to overlie the annular peripheral lid portion of the lid and crimped to hold the lid against the flange; and wherein the sidewall extends generally vertically and the seam is bent so as to project generally upwardly from the neck.

11. A container comprising
(a) a generally axially vertical container body including an open upper extremity and a metal sidewall with an outwardly projecting annular upper portion having an extended surface, the sidewall being formed with a reduced-diameter neck immediately below the outwardly projecting annular portion; and
(b) a metal top structure including an outwardly projecting annular portion with an extended surface in juxtaposed facing relation to said extended surface of the annular upper portion of the sidewall, the annular portion of the top structure being secured to the annular upper portion of the sidewall along an annular seam extending outwardly and substantially horizontally or downwardly from the sidewall;
(c) the seam including a metal seam member holding the annular portion of the top structure and the annular upper portion of the sidewall together.

12. A container as defined in claim 11, wherein the juxtaposed extended surfaces of the annular portions of the sidewall and the top structure are adhesively bonded together.

13. A container as defined in claim 11, wherein the metal seam member comprises a region of the annular portion of the sidewall that is welded to the annular portion of the top structure.

14. A container as defined in claim 11, wherein the metal seam member comprises an integral outer part of the annular portion of the sidewall, formed with a return bend to extend around the annular portion of the top structure and crimped to hold the annular portion of the top structure against the annular portion of the top structure.

15. A container as defined in claim 14, wherein the metal seam member has an inwardly curled outer edge.

16. A container as defined in claim 11, wherein the metal seam member comprises an inwardly opening U-shaped metal ring formed around and gripping the annular portions of the sidewall and the top structure to hold them together.

17. A container as defined in claim 16, wherein the metal ring has an inwardly curled outer edge.

18. A container as defined in claim 11, wherein the metal top structure has an aperture formed therein.

19. A container as defined in claim 11, wherein said outwardly projecting annular portion of the top structure is the lowermost portion of the top structure.

20. A method of producing a can containing a carbonated beverage, comprising:
(a) filling, with a carbonated beverage, a metal can body having an open upper extremity and including a sidewall with an inner surface, an outer surface and an annular upper edge portion at said upper extremity, said upper edge portion being formed into an outwardly projecting annular flange with an upper surface that is continuous with the inner surface of the sidewall and the sidewall being formed with a reduced-diameter neck immediately below the annular flange;
(b) disposing, in overlying relation to the annular flange, a can lid having an upper surface, a lower surface and an annular peripheral portion, the lid defining an aperture therein for pouring or drinking liquid from the can, and further including a flexible closure member extending entirely over the aperture and peelably bonded to the upper surface of the lid;
(c) adhesively bonding the lower surface of the lid at said annular peripheral portion to the upper surface of the annular flange; and
(c) adhesively bonding the lower surface of the lid at said annular peripheral portion to the upper surface of the annular flange; and
(d) forming a metal member to extend around the annular peripheral lid portion and bear against the upper surface of the lid to hold the annular peripheral lid portion and the annular flange together, with the annular peripheral lid portion having no return bend.
